(19) United States
(12) Patent Application Publication
(10) Pub. No.: US 2025/0199216 A1
(43) Pub. Date: Jun. 19, 2025

(54) OPTICAL FILTER

(71) Applicant: AGC Inc., Tokyo (JP)

(72) Inventors: Kazuhiko SHIONO, Fukushima (JP); Takashi NAGATA, Shizuoka (JP)

(73) Assignee: AGC Inc., Tokyo (JP)

(21) Appl. No.: 18/967,765

(22) Filed: Dec. 4, 2024

(30) Foreign Application Priority Data
Dec. 13, 2023 (JP) 2023-210430

(51) Int. Cl. G02B 5/20

(52) U.S. Cl. CPC G02B 5/208

(57) ABSTRACT

An optical filter includes: a dielectric multilayer film 1; a light-absorbing layer; a glass substrate; and a dielectric multilayer film 2 in this order, in which the dielectric multilayer film 1 has a thickness of 1,500 nm or more, the light-absorbing layer includes a resin having a glass transition temperature of 200° C. or higher and a near-infrared ray absorbing dye, and the optical filter satisfies spectral characteristics (i-1) and (i-2).

### CROSS-REFERENCE TO RELATED APPLICATIONS

This application claims priority from Japanese Patent Application No. 2023-210430 filed on Dec. 13, 2023, the entire subject matter of which is incorporated herein by reference.

### TECHNICAL FIELD

The present invention relates to an optical filter.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter.

Patent Literature 1 discloses an optical filter in which a dielectric multilayer film and a resin substrate containing a near-infrared ray absorbing dye are combined, and near-infrared light around 850 nm and visible light are transmitted and other light is shielded.

Patent Literature 2 discloses an optical filter in which a dielectric multilayer film and a resin substrate containing a near-infrared ray absorbing dye are combined, and near-infrared light around 940 nm and visible light are transmitted and other light is shielded.

### CITATION LIST

### Patent Literature

Patent Literature 1: WO2017-030174
Patent Literature 2: JP2016-200771A

### SUMMARY OF INVENTION

In recent years, with a diversification of sensing regions in the field of imaging, laser light including a partial near-infrared light region of 1,000 nm or more, of which a wavelength region is different from those in Patent Literatures 1 and 2, is used. Accordingly, there is a demand for an optical filter capable of transmitting near-infrared light in such sensing regions and shielding other near-infrared light which becomes a noise.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

An object of the present invention is to provide an optical filter that has an excellent transmissivity for a visible light and a specific near-infrared light and an excellent shielding property for other near-infrared light even at a high incident angle.

The present invention provides an optical filter having the following configuration.

According to the present invention, an optical filter that has excellent transmittance for visible light and specific near-infrared light and excellent shielding properties for other near-infrared light even at a high incident angle can be provided. The optical filter of the present invention is particularly an optical filter which is excellent in transmittance in a near-infrared light region of 1,000 nm to 1,300 nm including a sensing wavelength region even at a high incident angle and is hardly affected by the incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating spectral transmittance curves of glass.

FIG. 4 is a diagram illustrating spectral transmittance curves of light-absorbing layers.

FIG. 5 is a diagram illustrating spectral transmittance curves of an optical filter in Example 3.

FIG. 6 is a diagram illustrating spectral reflectance curves of the optical filter in Example 3.

FIG. 7 is a diagram illustrating spectral transmittance curves of an optical filter in Example 5.

FIG. 8 is a diagram illustrating spectral reflectance curves of the optical filter in Example 5.

### DESCRIPTION OF EMBODIMENTS

Hereinafter, embodiments of the present invention will be described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, spectra of transmittance of glass, transmittance of a light-absorbing layer including a case where a dye is contained in a resin, transmittance measured by dissolving a dye in a solvent such as dichloromethane, transmittance of a dielectric multilayer film, and transmittance of an optical filter having the dielectric multilayer film are all “external (measured) transmittance” including reflection losses of front and back surfaces even when described as “transmittance”.

In the present description, transmittance of, for example, 90% or more in a specific wavelength region means that the transmittance does not fall below 90% in the entire wavelength region, that is, minimum transmittance is 90% or more in the wavelength region. Similarly, transmittance of, for example, 1% or less in a specific wavelength region means that the transmittance does not exceed 1% in the entire wavelength region, that is, maximum transmittance is 1% or less in the wavelength region. Average transmittance in the specific wavelength region is an arithmetic mean of transmittance per 1 nm in the wavelength region. Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “the filter”) is an optical filter including a dielectric multilayer film 1, a light-absorbing layer, a glass substrate, and a dielectric multilayer film 2 in this order, in which the dielectric multilayer film 1 has a thickness of 1,500 nm or more, and the light-absorbing layer contains a resin having a glass transition temperature of 200° C. or higher and a near-infrared ray absorbing dye.

Reflection characteristics of the dielectric multilayer film and absorption characteristics of the light-absorbing layer allow the optical filter as a whole to achieve excellent transmittance in a visible light region and a specific near-infrared light region, and excellent shielding properties in another near-infrared light region.

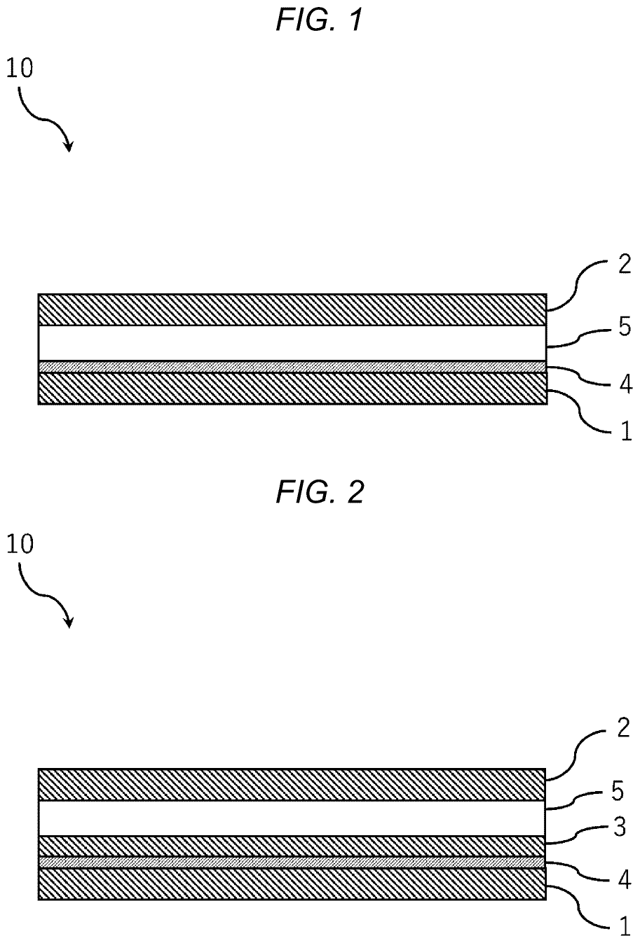

An example of a configuration of the filter will be described with reference to the drawings FIGS. 1 and 2 are cross-sectional views schematically illustrating examples of the optical filter according to one embodiment.

An optical filter 10 illustrated in FIG. 1 is an example in which the dielectric multilayer film 1, a light-absorbing layer 4, a glass substrate 5, and the dielectric multilayer film 2 are provided in this order.

An optical filter 10 illustrated in FIG. 2 is an example in which the dielectric multilayer film 1, the light-absorbing layer 4, a dielectric multilayer film 3, the glass substrate 5, and the dielectric multilayer film 2 are provided in this order.

The filter satisfies both the following spectral characteristics (i-1) and (i-2).
(i-1) When a sum of a transmittance of a light having a wavelength of 450 nm to 700 nm at an incident angle of 0 degrees is defined as S1₍₀₎, a sum of a transmittance of a light having a wavelength of 700 nm to 1,000 nm at an incident angle of 0 degrees is defined as S2₍₀₎, and a sum of a transmittance of a light having a wavelength of 1,000 nm to 1,300 nm at an incident angle of 0 degrees is defined as S3₍₀₎,
S1₍₀₎/S2₍₀₎≥40 and S3₍₀₎/S2₍₀₎≥40 are satisfied.
(i-2) When a sum of a transmittance of the light having a wavelength of 450 nm to 700 nm at an incident angle of 30 degrees is defined as S1₍₃₀₎, a sum of a transmittance of the light having a wavelength of 700 nm to 1,000 nm at an incident angle of 30 degrees is defined as S2₍₃₀₎, and a sum of a transmittance of the light having a wavelength of 1,000 nm to 1,300 nm at an incident angle of 30 degrees is defined as S3₍₃₀₎,
S1₍₃₀₎/S2₍₃₀₎≥40 and S3(30/S2₍₃₀₎≥40 are satisfied.
S1₍₀₎ and S1₍₃₀₎ correspond to transmission amounts of visible light at incident angles of 0 degrees and 30 degrees, respectively.
S2₍₀₎ and S2₍₃₀₎ correspond to transmission amounts of the light having a wavelength of 700 nm to 1,000 nm at incident angles of 0 degrees and 30 degrees, respectively.
S3₍₀₎ and S3₍₃₀₎ correspond to transmission amounts of the light having a wavelength of 1,000 nm to 1,300 nm at incident angles of 0 degrees and 30 degrees, respectively.

S1 is a wavelength region of a camera module, S3 is a sensing region, and in both regions, the larger the transmission amount of light is, the larger a quantity of light that can be captured is, enabling higher sensing.

On the other hand, S2 is a light shielding region, and thus S2 is preferably as small as possible from the viewpoint of reducing noise that causes a decrease in sensor sensitivity.

The filter satisfying the spectral characteristics (i-1) and (i-2) is a dual band pass filter which is excellent in balance between a transmission region and the light shielding region even at a high incident angle.

A sum of the transmittance of S1 to S3 can be obtained by adding transmittance (%) for each wavelength of 1 nm.
Preferably, S1₍₀₎/S2₍₀₎≥100 and S3₍₀₎/S2₍₀₎≥100.
Preferably, S1₍₃₀₎/S2₍₃₀₎≥200 and S3₍₃₀₎/S2₍₃₀₎≥200.

In order to satisfy the spectral characteristics (i-1) and (i-2), for example, the light shielding region of S2 may be shielded by absorption characteristics of the near-infrared ray absorbing dye or light-absorbing glass in which the spectral characteristics are not affected by the incident angle.

The filter preferably satisfies the following spectral characteristic (i-3).
(i-3) An absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.

The above absolute value of the difference between the wavelengths corresponds to a distance between a visible light transmission region S1 and a near-infrared light transmission region S3. The above absolute value is more preferably 350 nm or more.

In order to satisfy the spectral characteristic (i-3), in particular, in order to sufficiently separate a position of the near-infrared light transmission region S3 from the visible light transmission region S1, for example, it is possible to combine reflection characteristics of both the dielectric multilayer films 1 and 2, combine near-infrared ray absorbing dyes having different maximum absorption wavelengths, use the light-absorbing glass, or the like to perform light shielding in a wide region by combining a plurality of characteristics.

The filter preferably satisfies the following spectral characteristics (i-4) and (i-5).
(i-4) An absolute value of a difference between S1₍₀₎/S2₍₀₎ and S1₍₃₀₎/S2₍₃₀₎ is 200 or less.
(i-5) An absolute value of a difference between S3₍₀₎/S2₍₀₎ and S3₍₃₀₎/S2₍₃₀₎ is 200 or less.

Satisfying the spectral characteristic (i-4) means that the transmission amount of visible light and a transmission amount of near-infrared light in the light shielding region do not change even when the incident angle increases.

Satisfying the spectral characteristic (i-5) means that the transmission amount of the light having a wavelength of 1,000 nm to 1,300 nm and the transmission amount of the near-infrared light in the light shielding region do not change even when the incident angle increases.

That is, this means that a function of the dual band pass filter is hardly affected by the incident angle.

The absolute value of the difference in the spectral characteristic (i-4) is more preferably 130 or less, and further preferably 120 or less.

The absolute value of the difference in the spectral characteristic (i-5) is more preferably 130 or less, and further preferably 120 or less.

In order to satisfy the spectral characteristics (i-4) and (i-5), for example, both the dielectric multilayer film 1 and the dielectric multilayer film 2 may be responsible for light shielding properties based on the reflection characteristics in the light shielding region of the near-infrared light, the dielectric multilayer film 3 to be described later may be provided between the light-absorbing layer and the glass substrate, and the light-absorbing glass may be used as the glass substrate.

The filter preferably satisfies all of the following spectral characteristics (i-6) to (i-8).
(i-6) A wavelength IR_{50S} at which a reflectance of a light at an incident angle of 5 degrees is 50% is in a range of 650 nm to 830 nm when the light is incident from a dielectric multilayer film 1 side.
(i-7) A wavelength IR_{50L}, at which the reflectance of the light at an incident angle of 5 degrees is 50% is in a range of 950 nm to 1,200 nm when the light is incident from the dielectric multilayer film 1 side.
(i-8) An absolute value of a difference between the wavelength IR_{50S} and the wavelength IR_{50L} is 230 nm or more.

The spectral characteristics (i-6) to (i-8) substantially mean reflection characteristics of the dielectric multilayer film 1 on a light-absorbing layer side, and mean that the dielectric multilayer film 1 has reflection characteristics between a visible light region of 650 nm to 830 nm and a near-infrared light region of 950 nm to 1,200 nm.

The wavelength IR_{50S} is more preferably in a range of 700 nm to 780 nm, the wavelength IR_{50L} is more preferably in a range of 970 nm to 1,150 nm, and the absolute value of the difference between the wavelength IR_{50S} and the wavelength IR_{50L} is more preferably 240 nm or more.

In order to satisfy the spectral characteristics (i-6) to (i-8), for example, the dielectric multilayer film 1 designed to satisfy the above reflection characteristics may be provided.

The filter preferably satisfies both the following spectral characteristics (i-9) and (i-10).
(i-9) An average reflectance of a light having a wavelength of 450 nm to 600 nm at an incident angle of 5 degrees is 5% or less when the light is incident from a dielectric multilayer film 1 side.
(i-10) An average reflectance of the light having a wavelength of 450 nm to 600 nm at an incident angle of 5 degrees is 5% or less when the light is incident from a dielectric multilayer film 2 side.

The spectral characteristic (i-9) substantially means reflection characteristics of the dielectric multilayer film 1 in a visible light region, and the spectral characteristic (i-10) substantially means reflection characteristics of the dielectric multilayer film 2 in the visible light region. Both the spectral characteristics mean that the reflection characteristics with respect to visible light are small.

The average reflectance in the spectral characteristic (i-9) is more preferably 4.8% or less.

The average reflectance in the spectral characteristic (i-10) is more preferably 4.8% or less.

In order to satisfy the spectral characteristics (i-9) and (i-10), for example, the dielectric multilayer film 1 and the dielectric multilayer film 2 designed to satisfy the above reflection characteristics may be provided.

The filter preferably satisfies the following spectral characteristic (i-11).
(i-11) An absolute value of a difference between an average reflectance of a light having a wavelength of 450 nm to 600 nm at an incident angle of 5 degrees when the light is incident from a dielectric multilayer film 1 side and an average reflectance of the light having a wavelength of 450 nm to 600 nm at an incident angle of 5 degrees when the light is incident from a dielectric multilayer film 2 side is 0.5% or less.

The spectral characteristic (i-11) corresponds to a difference between the reflection characteristics of the dielectric multilayer film 1 and the dielectric multilayer film 2 in the visible light region, and means that the reflection characteristics are comparable when the above range is satisfied.

The absolute value of the difference in the spectral characteristic (i-11) is more preferably 0.4% or less.

In order to satisfy the spectral characteristic (i-11), for example, the dielectric multilayer film 1 and the dielectric multilayer film 2 designed to satisfy the above reflection characteristics may be provided.

### <Glass Substrate>

The filter includes a glass substrate. Since the filter includes at least two dielectric multilayer films, a material having high rigidity such as glass is preferable instead of a resin film as a substrate. Thus, warpage during film formation can be reduced.

The glass substrate may be a transparent glass substrate or a light-absorbing glass substrate, and a light-absorbing glass substrate is preferable. The reflection characteristics of the dielectric multilayer film are such that the light shielding region is shifted depending on the incident angle of light. On the other hand, the absorption characteristics of the light-absorbing glass substrate are such that the shift of the light shielding region depending on the incident angle of light is small, and high light shielding properties can be exhibited even at a high incident angle.

The light-absorbing glass is preferably a glass containing ytterbium. The glass containing ytterbium has a characteristic of absorbing light in a near-infrared light region having a wavelength of 900 nm to 1,000 nm. Further, since a waveform of an absorption band is steep, transmittance in a region other than a maximum absorption wavelength region is excellent. Therefore, transmittance is excellent in the visible light region and in a region from visible light to near-infrared light having a wavelength of about 800 nm and on a wavelength side longer than a wavelength of 1,000 nm.

Each component that can constitute the glass and a preferred content thereof (in terms of mol % based on an oxide) will be described below. In the present description, unless otherwise specified, the content of each component and the total content are represented by mol % based on oxides.

Yb₂O₃ is a component for efficiently absorbing light having a wavelength around 900 nm to 1,000 nm, particularly light having a wavelength of 940 nm, and reducing the transmittance. In the glass of the present embodiment, when a content of Yb₂O₃ is 20% or more, an effect thereof can be sufficiently obtained, and when the content is 60% or less, problems such as deterioration of devitrification resistance of the glass, deterioration of meltability, and generation of stray light due to fluorescence are unlikely to occur.

Therefore, the content of Yb₂O₃ is preferably 20% to 60%, more preferably 25% to 60%, further preferably 30% to 60%, still more preferably 35% to 60%, particularly preferably more than 40% and 60% or less, and most preferably 45% to 60%.

SiO₂ is a main component that forms the glass, and is a component for improving devitrification resistance and viscosity with respect to a liquid phase temperature of the glass. In the glass of the present embodiment, when a content of SiO₂ is 0.1% or more, problems such as unstability of the glass, reduction in weather resistance, and generation of striae in the glass are unlikely to occur. When the content of SiO₂ is 50% or less, problems such as deterioration of glass meltability are unlikely to occur.

Therefore, the content of SiO₂ is preferably 0.1% to 50%, more preferably 0.1% to 40%, further preferably 0.1% to 30%, still more preferably 0.1% to 20%, particularly preferably 0.1% to 10%, and most preferably 0.1% to 9%.

B₂O₃ is a main component that forms the glass, and is a component for improving devitrification resistance and viscosity with respect to a liquid phase temperature of the glass. In the glass of the present embodiment, when a content of B₂O₃ is 15% or more, problems such as unstability of glass are unlikely to occur. When the content of B₂O₃ is 40% or less, problems such as reduction in weather resistance of the glass and generation of striae in the glass are unlikely to occur.

Therefore, the content of B₂O₃ is preferably 15% to 40%, more preferably 15% to 38%, further preferably 15% to 36%, still more preferably 15% to 34%, particularly preferably 15% to 32%, and most preferably 15% to 30%.

The light-absorbing glass preferably contains at least one of SiO₂ and B₂O₃ from the viewpoint of obtaining a stable glass. A total content of the above components is preferably more than 65% from the viewpoint of hardly causing problems such as unstability of glass, and is preferably 80% or less from the viewpoint of hardly causing problems such as deterioration of glass meltability.

Therefore, the total content is more preferably more than 65% and 79% or less, further preferably more than 65% and 78% or less, still more preferably more than 65% and 77% or less, particularly preferably more than 65% and 76% or less, and most preferably more than 65% and 75% or less.

P₂O₅ is a component for improving meltability and stability of the glass. In the glass of the present embodiment, a content of P₂O₅ is preferably 0% to 15%. When the content of P₂O₅ is 15% or less, problems such as deterioration in weather resistance of the glass, phase separation of the glass, and generation of striae in the glass are unlikely to occur.

The content of P₂O₅ is more preferably 1% to 13%, further preferably 2% to 12%, still more preferably 3% to 11%, and most preferably 4% to 10%.

GeO₂ is a component for improving devitrification resistance and viscosity with respect to a liquid phase temperature of the glass. In the glass of the present embodiment, a content of GeO₂ is preferably 0% to 15%. When the content of GeO₂ is 15% or less, problems such as deterioration in glass meltability are unlikely to occur.

The content of GeO₂ is more preferably 0% to 13%, further preferably 0% to 11%, still more preferably 0% to 9%, and most preferably 0% to 7%.

Ga₂O₃ is a component for increasing the Young's modulus of the glass and improving the meltability and the stability. In the glass of the present embodiment, a content of Ga₂O₃ is preferably 0% to 30%. When the content of Ga₂O₃ is 30% or less, problems such as deterioration of devitrification resistance of the glass, increase of reflectance, and generation of stray light due to reflected light are unlikely to occur.

The content of Ga₂O₃ is more preferably 0.5% to 28%, further preferably 1% to 26%, still more preferably 2% to 24%, and most preferably 3% to 22%.

ZrO₂ is a component for increasing the Young's modulus of the glass and improving viscosity with respect to a liquid phase temperature of the glass. In the glass of the present embodiment, a content of ZrO₂ is preferably 0% to 7%. When the content of ZrO₂ is 7% or less, problems such as deterioration of devitrification resistance of the glass and deterioration of meltability are unlikely to occur.

The content of ZrO₂ is more preferably 0% to 6%, further preferably 0% to 5%, still more preferably 0% to 4%, and most preferably 0% to 3%.

La₂O₃ is a component for increasing the Young's modulus of the glass and improving the meltability. In the glass of the present embodiment, a content of La₂O₃ is preferably 0.1% to 20%. When the content of La₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content of La₂O₃ is more preferably 0.5% to 19%, further preferably 1% to 18%, still more preferably 2% to 17%, and most preferably 2% to 16%.

Al₂O₃ is a component for increasing the Young's modulus of the glass and reducing the refractive index of the glass. In the glass of the present embodiment, a content of Al₂O₃ is preferably 0.1% to 20%. When the content of Al₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content is more preferably 0.1% to 18%, further preferably 0.1% to 15%, still more preferably 0.1% to 13%, and most preferably 0.1% to 11%.

A ratio of a total content of components of Al₂O₃, GeO₂, Ga₂O₃, and P₂O₅ to a total content of components of SiO₂ and B₂O₃, that is, (total content of Al₂O₃, GeO₂, Ga₂O₃, and P₂O₅)/(total content of SiO₂ and B₂O₃) is preferably less than 0.1 from the viewpoint of vitrifying glass containing a Yb component without devitrifying the glass.

The light-absorbing glass may contain an alkali metal oxide, an alkaline earth metal oxide, Sb₂O₃, Cl, F, and other components as long as the object of the present invention is not impaired.

As the glass substrate in the filter, when being used for an optical filter, it is desirable that reflectance of glass is reduced in order to prevent occurrence of stray light due to reflected light on a glass surface. The reflectance of the glass is determined by a refractive index. Typically, a refractive index at a wavelength of 588 nm is preferably 1.700 to 1.900.

As the glass substrate, when being used in a so-called dual band pass filter having a function of selectively transmitting visible light and specific near-infrared light, the glass substrate is usually used with a thickness of 3 mm or less. From the viewpoint of reducing a weight of the component, the thickness is preferably 2 mm or less, more preferably 1 mm or less, further preferably 0.5 mm or less, and still more preferably 0.3 mm or less. From the viewpoint of ensuring the strength of the glass, the thickness thereof is preferably 0.05 mm or more.

The glass substrate in the filter can be prepared, for example, as follows.

First, raw materials are weighed and mixed so as to fall within the above composition range (mixing step). The raw material mixture is accommodated in a platinum crucible, and heated and melted at a temperature of 1,200° C. to 1,650° C. in an electric furnace (melting step). After being sufficiently stirred and refined, the raw material mixture is cast into a mold, cut and polished to form a flat plate having a predetermined thickness (molding step).

In the melting step of the above manufacturing method, the highest temperature of the glass during glass melting is preferably 1,650° C. or lower. When the highest temperature of the glass during melting is equal to or lower than the above temperature, problems such as crystallization of the glass and generation of un-melted foreign matter in the glass are unlikely to occur. The above temperature is more preferably 1,625° C. or lower, and further preferably 1,600° C. or lower.

When the temperature in the melting step is too low, problems such as devitrification occurring during melting and a long time required for burn-through may occur, and thus the temperature is preferably 1,300° C. or higher, and more preferably 1,350° C. or higher.

### <Light-Absorbing Layer>

The filter includes a light-absorbing layer containing a resin having a glass transition temperature of 200° C. or higher and a near-infrared ray absorbing dye (NIR dye). Accordingly, it is possible to compensate for a region where light is not shielded due to the reflection characteristics of the dielectric multilayer film by the absorption characteristics that are not affected by the incident angle. In addition, even when a strong stress is applied to the dielectric multilayer film 1 on the light-absorbing layer, the resin is hardly deformed because the glass transition temperature of the resin is sufficiently high.

The light-absorbing layer preferably satisfies both the following spectral characteristics (ii-1) and (ii-2). (ii-1) An average transmittance of a light having a wavelength of 450 nm to 600 nm is 70% or more. (ii-2) An average transmittance of a light having a wavelength of 700 nm to 900 nm is 60% or less.

As the near-infrared ray absorbing dye, from the viewpoint of being able to absorb a wide range of light in the near-infrared region while maintaining the transmittance in the visible light region, preferably a combination of two or more kinds of, more preferably three kinds of dyes having different maximum absorption wavelengths and existing in a region of 680 nm to 800 nm may be used. In particular, the near-infrared ray absorbing dye preferably includes a dye having a maximum absorption wavelength at a wavelength of 700 nm or more and less than 730 nm, a dye having a maximum absorption wavelength at a wavelength of 730 nm or more and less than 760 nm, and a dye having a maximum absorption wavelength at a wavelength of 760 nm or more and less than 800 nm.

The NIR dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The NIR dye preferably contains at least one dye selected from a squarylium dye, a phthalocyanine dye, and a cyanine dye. Among these NIR dyes, a squarylium dye and a cyanine dye are preferable from the viewpoint of spectroscopy, and a phthalocyanine dye is preferable from the viewpoint of durability.

A content of the NIR dye in the light-absorbing layer is preferably 10 mass % or more in order to obtain desired optical characteristics. When the content of the NIR dye is too large, physical properties of the light-absorbing layer are impaired (particularly, glass transition point is lowered), and thus the content is preferably 20 mass % or less, and more preferably 15 mass % or less. Even when the content of the NIR dye is 10 mass % or more, the light-absorbing layer is hardly thermally deformed because the glass transition temperature of the resin is sufficiently high. In a case where two or more compounds are combined, the above content is a sum of respective compounds.

The light-absorbing layer may include other dyes in addition to the above NIR dye. Examples of the other dyes preferably include a dye (UV dye) having a maximum absorption wavelength in 370 nm to 440 nm in the resin. Accordingly, a near ultraviolet region can be efficiently shielded.

Examples of the UV dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among those, the merocyanine dye is particularly preferable. In addition, these dyes may be used alone, or may be used in combination of two or more kinds thereof.

As the resin in the light-absorbing layer of the filter, a resin having a glass transition temperature of 200° C. or higher is used from the viewpoint of preventing deformation as described above. In addition, a transparent resin is preferable from the viewpoint of not affecting the spectral characteristics. The resin having a glass transition temperature of 200° C. or higher is preferably one or more resins selected from a polyimide resin, a polycarbonate resin, a polyester resin, and an acrylic resin. The glass transition temperature of the resin is preferably 250° C. or higher, and more preferably 300° C. or higher.

In a case where a plurality of compounds are used as the NIR dye or other dyes, those compounds may be included in the same light-absorbing layer or may be included in different light-absorbing layers.

The light-absorbing layer can be formed by dissolving or dispersing a dye, a resin or raw material components of the resin, and respective components blended as necessary in a solvent to prepare a coating solution, applying the coating solution to a support, drying the coating solution, and further curing the coating solution as necessary. The support may be a light-absorbing glass substrate or may be a peelable support used only when the light-absorbing layer is formed. In addition, the solvent may be a dispersion medium capable of stably dispersing components or a solvent capable of dissolving components.

In addition, the coating solution may contain a surfactant in order to improve voids due to fine bubbles, depressions due to adhesion of foreign substances and the like, and repelling in a drying process. Further, for the application of the coating solution, for example, a dip coating method, a cast coating method, or a spin coating method can be used. In addition, in a case where the coating solution contains a raw material component of the transparent resin, a curing process such as thermal curing or photocuring is further performed.

The light-absorbing layer can also be manufactured into a film shape by extrusion molding. The filter can be manufactured by laminating the obtained film-shaped absorption layer on the light-absorbing glass substrate and integrating those by thermal press fitting or the like.

The light-absorbing layer may be provided in the optical filter by one layer or two or more layers. In a case where the light-absorbing layer is provided by two or more layers, respective layers may have the same configuration or different configurations.

A thickness of the light-absorbing layer is preferably 5 μm or less from the viewpoint of coating properties, and in-plane film thickness distribution and appearance quality in a substrate after coating, and more preferably 2 μm or less from the viewpoint of reducing an amount of thermal expansion of the resin, and is preferably 0.5 μm or more from the viewpoint of exhibiting desired spectral characteristics at an appropriate dye concentration. In a case where the optical filter has two or more layers of light-absorbing layers, a total thickness of the respective light-absorbing layers is preferably within the above range.

### <Dielectric Multilayer Film>

The filter includes the dielectric multilayer film 1 on a surface of the light-absorbing layer, and the dielectric multilayer film 2 on or above one main surface of the glass substrate. The larger a thickness of the dielectric multilayer film, the easier to control the spectral characteristics. On the other hand, when the thickness is too large, a stress is likely to be generated, which may cause deformation. By providing the dielectric multilayer films at two positions, it is possible to disperse the role in controlling the spectral characteristics and avoid the thickness from being concentrated on one of the multilayer films.

Both the dielectric multilayer films 1 and 2 are preferably designed as reflective films (hereinafter, also referred to as “NIR reflective films”) that reflect a part of near-infrared light. The NIR reflection films may be further appropriately designed to have a specification further reflecting light in a wavelength range other than the near-infrared light, for example, near ultraviolet light.

The dielectric multilayer film 1 preferably satisfies all of the following spectral characteristics (iii-1-1) to (iii-1-3). (iii-1-1) An average reflectance of a light having a wavelength of 450 nm to 600 nm at an incident angle of 5 degrees is 2.0% or less. (iii-1-2) An average reflectance of a light having a wavelength of 430 nm to 700 nm at an incident angle of 5 degrees is 2.5% or less. (iii-1-3) An average reflectance of a light having a wavelength of 1,110 nm to 1,200 nm at an incident angle of 5 degrees is 5.0% or less.

Satisfying the above characteristics is particularly preferable because an optical filter that satisfies the spectral characteristics (i-6) to (i-8) and the spectral characteristics (i-9) is easily obtained. In addition, since the sum S1 of the transmittance of the visible light can be increased and the sum S2 of the transmittance of the light having a wavelength of 700 nm to 1,000 nm can be reduced, an optical filter that satisfies S1₍₀₎/S2₍₀₎ of the spectral characteristic (i-1) and S1₍₃₀₎/S2₍₃₀₎ of the spectral characteristic (i-2) can be easily obtained.

The dielectric multilayer film 2 preferably satisfies all of the following spectral characteristics (iii-2-1) to (iii-2-3). (iii-2-1) The average reflectance of the light having a wavelength of 450 nm to 600 nm at an incident angle of 5 degrees is 2.0% or more. (iii-2-2) The average reflectance of the light having a wavelength of 430 nm to 700 nm at an incident angle of 5 degrees is 2.5% or less. (iii-2-3) The average reflectance of the light having a wavelength of 1,110 nm to 1,200 nm at an incident angle of 5 degrees is 5.0% or less.

Satisfying the above characteristics is particularly preferable because an optical filter that satisfies the spectral characteristic (i-10) is easily obtained.

The filter preferably includes the dielectric multilayer film 3 between the light-absorbing layer and the glass substrate. The three dielectric multilayer films can more flexibly control the spectral characteristics. Specifically, the absolute value of the difference between S1₍₀₎/S2₍₀₎ and S1₍₃₀₎/S2₍₃₀₎ and the absolute value of the difference between S3₍₀₎/S2₍₀₎ and S3₍₃₀₎/S2₍₃₀₎ can be made smaller, and an optical filter satisfying the spectral characteristics (i-4) and (i-5) can be easily obtained.

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band.

A refractive index of a high refractive index material at a wavelength of 500 nm is preferably 1.8 or more and 2.5 or less, and more preferably 1.9 or more and 2.5 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among those, TiO₂ is preferable from the viewpoint of reproducibility in film formability and refractive index, stability, and the like.

A refractive index of a medium refractive index material at a wavelength of 500 nm is preferably more than 1.5 and less than 1.8, and more preferably 1.55 or more and less than 1.8. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like. The medium refractive index film may be replaced with an equivalent film including a high refractive index film and a low refractive index film without using the medium refractive index material described above.

A refractive index of a low refractive index material at a wavelength of 500 nm is preferably 1.4 or more and 1.5 or less, and more preferably 1.45 or more and 1.5 or less. Examples of the low refractive index material include SiO₂, SiOₓN_{y}, and MgF₂. Other commercially available products thereof include S4F and S5F (mixtures of SiO₂ and Al₂O₃) manufactured by Canon Optron, Inc. Among those, SiO₂ is preferable from the viewpoint of reproducibility in film formability, stability, economic efficiency, and the like.

A film thickness (physical film thickness) of the dielectric multilayer film 1 is preferably 1,500 nm or more and more preferably 2,000 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 1 is preferably 100 or less, more preferably 80 or less, and still more preferably 70 or less, from the viewpoint of productivity and viability.

A film thickness (physical film thickness) of the dielectric multilayer film 2 is preferably 1,500 nm or more and more preferably 2,000 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 2 is preferably 100 or less, more preferably 80 or less, and still more preferably 70 or less, from the viewpoint of productivity and viability.

A film thickness (physical film thickness) of the dielectric multilayer film 3 is preferably 150 nm or more and more preferably 200 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 3 is preferably 100 or less, more preferably 50 or less, and still more preferably 25 or less, from the viewpoint of productivity and viability.

For formation of the dielectric multilayer film, for example, a vacuum film formation process such as a CVD method, a sputtering method, or a vacuum deposition method, a wet film formation process such as a spraying method or a dipping method, or the like can be used.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing properties in a wide range of an infrared wavelength region exceeding 1,200 nm, and thus can be used in a case where shielding properties of infrared light are required.

### <Imaging Device>

The imaging device according to the present invention preferably includes the optical filter according to the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the filter which is excellent in transmittance of visible light and specific near-infrared light, has shielding properties of specific near-infrared light, and has a spectral curve hardly shifted even at a high incident angle, it is possible to obtain an imaging device excellent in color reproducibility even for light at a high incident angle.

When the optical filter is to be mounted on the imaging device, it is generally preferable that the dielectric multilayer film 2 (substrate side) be on a lens side and the dielectric multilayer film 1 (light-absorbing layer side) be on a sensor side.

As described above, the present description discloses the following optical filters and the like.
(1) An optical filter including a dielectric multilayer film 1, a light-absorbing layer, a glass substrate, and a dielectric multilayer film 2 in this order, in which
the dielectric multilayer film 1 has a thickness of 1,500 nm or more,
the light-absorbing layer contains a resin having a glass transition temperature of 200° C. or higher and a near-infrared ray absorbing dye, and
the optical filter satisfies the following spectral characteristics (i-1) and (i-2):
(i-1) when a sum of a transmittance of a light having a wavelength of 450 nm to 700 nm at an incident angle of 0 degrees is defined as S1₍₀₎, a sum of a transmittance of a light having a wavelength of 700 nm to 1,000 nm at an incident angle of 0 degrees is defined as S2₍₀₎, and a sum of a transmittance of a light having a wavelength of 1,000 nm to 1,300 nm at an incident angle of 0 degrees is defined as S3₍₀₎,
S1₍₀₎/S2₍₀₎≥40 and S3₍₀₎/S2₍₀₎≥40 are satisfied, and
(i-2) when a sum of a transmittance of the light having a wavelength of 450 nm to 700 nm at an incident angle of 30 degrees is defined as S1₍₃₀₎, a sum of a transmittance of the light having a wavelength of 700 nm to 1,000 nm at an incident angle of 30 degrees is defined as S2₍₃₀₎, and a sum of a transmittance of the light having a wavelength of 1,000 nm to 1,300 nm at an incident angle of 30 degrees is defined as S3₍₃₀₎,
S1₍₃₀₎/S2₍₃₀₎≥40 and S3₍₃₀₎/S2₍₃₀₎≥40 are satisfied.
[2] The optical filter according to [1], in which the optical filter further satisfies the following spectral characteristic (i-3):
(i-3) an absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.
[3] The optical filter according to [1] or [2], in which the optical filter satisfies the following spectral characteristics (i-4) and (i-5):
(i-4) an absolute value of a difference between S1₍₀₎/S2₍₀₎ and S1₍₃₀₎/S2₍₃₀₎ is 200 or less, and
(i-5) an absolute value of a difference between S3₍₀₎/S2₍₀₎ and S3₍₃₀₎/S2₍₃₀₎ is 200 or less.
[4] The optical filter according to any of [1] to [3], in which the optical filter further satisfies all of the following spectral characteristics (i-6) to (i-8):
(i-6) a wavelength IR_{50S} at which a reflectance of a light at an incident angle of 5 degrees is 50% is in a range of 650 nm to 830 nm when the light is incident from a dielectric multilayer film 1 side,
(i-7) a wavelength IR_{50L} at which the reflectance of the light at an incident angle of 5 degrees is 50% is in a range of 950 nm to 1,200 nm when the light is incident from the dielectric multilayer film 1 side, and
(i-8) an absolute value of a difference between the wavelength IR_{50S} and the wavelength IR_{50L} is 230 nm or more.
[5] The optical filter according to any of [1] to [4], in which the optical filter satisfies both the following spectral characteristics (i-9) and (i-10):
(i-9) an average reflectance of a light having a wavelength of 450 nm to 600 nm at an incident angle of 5 degrees is 5% or less when the light is incident from a dielectric multilayer film 1 side, and
(i-10) an average reflectance of the light having a wavelength of 450 nm to 600 nm at an incident angle of 5 degrees is 5% or less when the light is incident from a dielectric multilayer film 2 side.
[6] The optical filter according to any of [1] to [5], in which the optical filter satisfies the following spectral characteristic (i-11):
(i-11) an absolute value of a difference between an average reflectance of a light having a wavelength of 450 nm to 600 nm at an incident angle of 5 degrees when the light is incident from a dielectric multilayer film 1 side and an average reflectance of the light having a wavelength of 450 nm to 600 nm at an incident angle of 5 degrees when the light is incident from a dielectric multilayer film 2 side is 0.5% or less.
[7] The optical filter according to [3], in which the optical filter includes a dielectric multilayer film 3 between the light-absorbing layer and the glass substrate,
the absolute value of the difference between S1₍₀₎/S2₍₀₎ and S1₍₃₀₎/S2₍₃₀₎ in the spectral characteristic (i-4) is 130 or less, and
the absolute value of the difference between S3₍₀₎/S2₍₀₎ and S3₍₃₀₎/S2₍₃₀₎ in the spectral characteristic (i-5) is 130 or less.
[8] The optical filter according to [3], in which the glass substrate is an ytterbium-containing glass substrate,
the absolute value of the difference between S1₍₀₎/S2₍₀₎ and S1₍₃₀₎/S2₍₃₀₎ in the spectral characteristic (i-4) is 130 or less; and
the absolute value of the difference between S3₍₀₎/S2₍₀₎ and S3₍₃₀₎/S2₍₃₀₎ in the spectral characteristic (i-5) is 130 or less.
[9] The optical filter according to any of [1] to [8], in which the resin in the light-absorbing layer contains a polyimide resin.

[10] The optical filter according to any of [1] to [9], in which the near-infrared ray absorbing dye in the light-absorbing layer includes:
a dye having a maximum absorption wavelength at a wavelength of 700 nm or more and less than 730 nm;
a dye having a maximum absorption wavelength at a wavelength of 730 nm or more and less than 760 nm; and
a dye having a maximum absorption wavelength at a wavelength of 760 nm or more and less than 800 nm.
[11] The optical filter according to any of [1] to [10], in which the light-absorbing layer has a thickness of 2 μm or less, and
a content of the near-infrared ray absorbing dye in the light-absorbing layer is 10 mass % or more.
[12] An imaging device including the optical filter according to any of [1] to [11].

### EXAMPLES

Next, the present invention will be described more specifically with reference to examples.

For measurement of each spectral characteristic, an ultraviolet-visible spectrophotometer (UH-4150 type, manufactured by Hitachi High-Tech Corporation) was used.

The spectral characteristic in a case where an incident angle is not particularly specified is a value measured at an incident angle of 0 degrees (in a direction perpendicular to a main surface of an optical filter).

Dyes used in respective examples are as follows.

Compound 1 (squarylium compound): synthesized based on U.S. Pat. No. 5,543,086. Compound 2 (squarylium compound): synthesized based on WO2017/135359. Compound 3 (merocyanine compound): synthesized based on the description of German Patent No. 10109243. Compound 4 (cyanine compound): synthesized based on Dyes and pigments 73 (2007) 344-352.

Compound 5 (cyanine compound): synthesized based on Dyes and pigments 73 (2007) 344-352.

The compound 1, the compound 2, the compound 4, and the compound 5 are near-infrared ray absorbing dyes (NIR dyes), and the compound 3 is a near ultraviolet absorbing dye (UV dye).

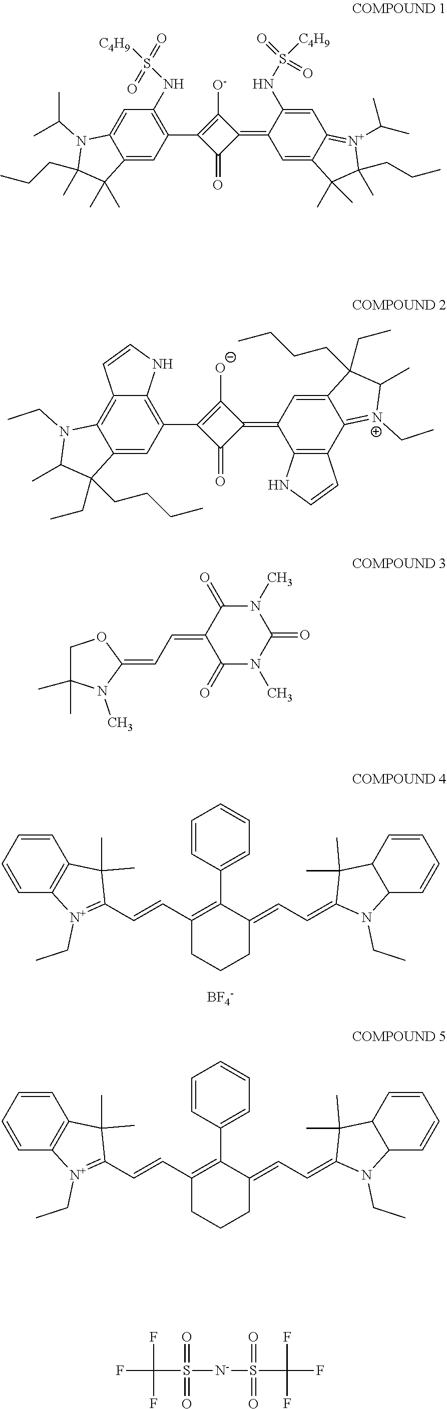

### <Spectral Characteristics of Dye>

Maximum absorption wavelengths in absorption spectrums measured after dissolving the above dyes (compounds 1 to 5) in dichloromethane are shown in Table 1 below.

### <Glass Substrate>

As the glass substrate, a glass A which is a light-absorbing glass, and a non-absorbing glass B were prepared.

As the glass A, raw materials including, in terms of mol % based on an oxide, 7.5% of SiO₂, 23.6% of B₂O₃, 7.5% of P₂O₅, 47.2% of Yb₂O₃, 11.8% of Ga₂O₃, and 2.4% of La₂O₃ were weighed and mixed, placed in a crucible having an internal volume of about 400 cc, and melted at 1,400° C. to 1,650° C. for 2 hours in an air atmosphere. Thereafter, the mixture was clarified, stirred, cast into a rectangular mold having a length of 100 mm, a width of 50 mm, and a height of 20 mm that was preheated to about 300° C. to 500° C., slowly cooled to room temperature at about −1° C./min, cut to have a predetermined thickness within a range of a length of 40 mm, a width of 30 mm, and a thickness of 0.3 mm to 1.5 mm, and optically polished on both sides to obtain a plate-shaped glass.

In addition, the glass B is a non-absorbing glass, and a D263 glass (borosilicate glass, commercially available product, manufactured by Schott) was used.

The following raw materials were used for each glass.
SiO₂: oxide
B₂O₃: one or more selected from an oxide, PBO₄, and H₃BO₃
P₂O₅: any one or more of H₃PO₄ and PBO₄
GeO₂: oxide
ZrO₂: oxide
Ga₂O₃: oxide
Yb₂O₃: oxide
La₂O₃: oxide
Al₂O₃: any one or more of an oxide and Al(OH)₃

The raw materials of the glass are not limited to the above, and known raw materials can be used.

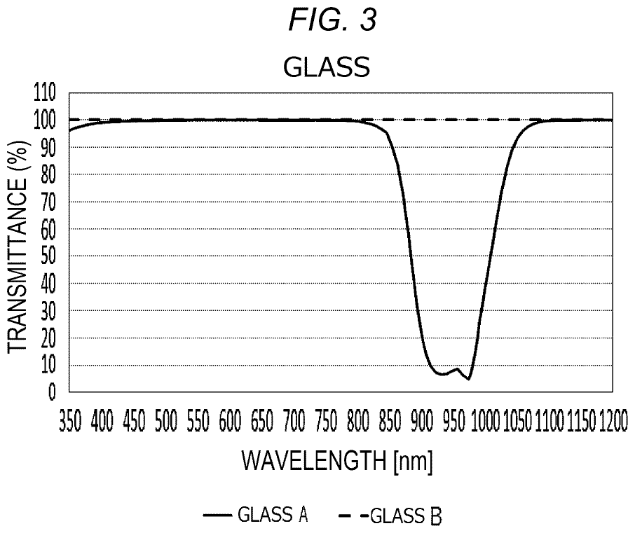

Transmittance curves for light having a wavelength of 350 nm to 1,200 nm of the glass A and the glass B (sheet thickness of both glass A and glass B: 0.4 mm, internal transmittance) are illustrated in FIG. 3.

### <Light-Absorbing Layer>

Any of the dyes of the compounds 1 to 5 was dissolved in a polyimide resin (C-3G30G, manufactured by Mitsubishi Gas Chemical Company, Inc.) or a polyester resin (polyester resin, manufactured by Osaka Gas Chemicals Co., Ltd.), mixed at a concentration shown in the following table, and stirred and dissolved at 50° C. for 2 hours to obtain a coating solution.

The obtained coating solution was applied onto an alkali glass (D263 glass, thickness: 0.2 mm, manufactured by SCHOTT) by a spin coating method to form a light-absorbing layer having a film thickness shown in the following Table 1.

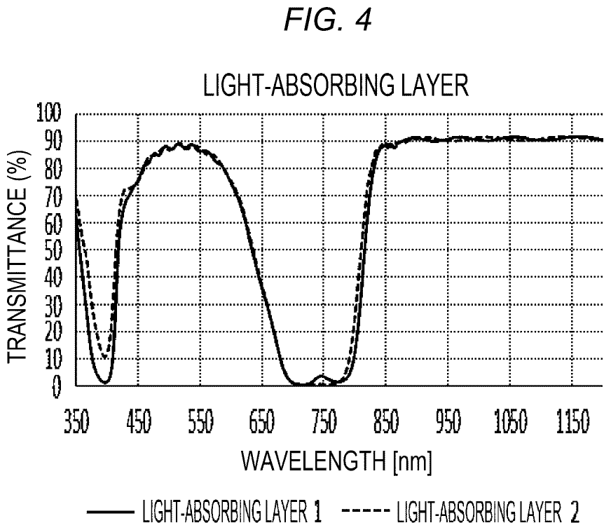

In addition, transmittance curves for the light having a wavelength of 350 nm to 1,200 nm of the light-absorbing layers 1 and 2 are illustrated in FIG. 4.

TABLE 1

| | | Light-absorbing | Light-absorbing | Light-absorbing |
|---|---|---|---|---|
| | | layer 1 | layer 2 | layer 3 |
| Resin | | Polyimide | Polyimide | Polyester |
| Added amount of | Compound 1 (λMAX: 773 nm) | — | 2.8 | — |
| dye (mass %) | Compound 2 (λMAX: 752 nm) | — | 4.0 | — |
| | Compound 3 (λMAX: 397 nm) | 4.9 | 2.9 | 4.9 |
| | Compound 4 (λMAX: 713 nm) | 4.1 | 4.7 | 4.1 |
| | Compound 5 (λMAX: 772 nm) | 5.6 | — | 5.6 |
| | Total | 14.6 | 14.5 | 14.6 |

| | | | |
|---|---|---|---|
| Film thickness (μm) | 1.4 | 1.1 | 1.4 |

### Example 1: Optical Filter

A dielectric multilayer film 2A was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1A was formed by alternately laminating SiO₂ and TiO₂ on a surface of the light-absorbing layer by vapor deposition.

Thus, an optical filter of Example 1 was manufactured.

### Example 2

An optical filter of Example 2 was manufactured in the same manner as in Example 1 except that a light-absorbing glass A was used instead of the glass B as the glass substrate and a dielectric multilayer film 1B was used instead of the dielectric multilayer film 1A.

### Example 3

An optical filter of Example 3 was manufactured in the same manner as in Example 1 except that a dielectric multilayer film 3A was formed by alternately laminating SiO₂ and TiO₂ between the glass substrate and the light-absorbing layer by vapor deposition.

### Example 4

An optical filter of Example 4 was manufactured in the same manner as in Example 2 except that a dielectric multilayer film 3A was formed by alternately laminating SiO₂ and TiO₂ between the glass substrate and the light-absorbing layer by vapor deposition.

### Example 5

A dielectric multilayer film 2B was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 2, and an organic solvent was removed by sufficiently heating, thereby forming a light-absorbing layer.

A dielectric multilayer film 1C was formed by alternately laminating SiO₂ and TiO₂ on a surface of the light-absorbing layer by vapor deposition.

Thus, an optical filter of Example 5 was manufactured.

### Example 6

A dielectric multilayer film 2C was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1D was formed by alternately laminating SiO₂ and TiO₂ on a surface of the light-absorbing layer by vapor deposition.

Thus, an optical filter of Example 6 was manufactured.

### Example 7

A dielectric multilayer film 2D was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1E was formed by alternately laminating SiO₂ and TiO₂ on a surface of the light-absorbing layer by vapor deposition.

Thus, an optical filter of Example 7 was manufactured.

### Example 8

A dielectric multilayer film 2E was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1C was formed by alternately laminating SiO₂ and TiO₂ on a surface of the light-absorbing layer by vapor deposition.

Thus, an optical filter of Example 8 was manufactured.

### Example 9

An optical filter of Example 9 was manufactured in the same manner as in Example 2 except that a light-absorbing layer having the same composition as that of the light-absorbing layer 3 was formed instead of the light-absorbing layer 1.

Configurations of the dielectric multilayer films 1A, 1B, 2A, and 3A are shown in the following Tables 2 to 4, respectively. An order of the numbers (No.) corresponds to a lamination order.

TABLE 2

| Type of multilayer film: 1A | | | | | | Type of multilayer film: 1B | | |
|---|---|---|---|---|---|---|---|---|
| | Film | Physical film thickness | | Film | Physical film thickness | | Film | Physical film thickness |
| No. | material | [nm] | No. | material | [nm] | No. | material | [nm] |
| Air side | | | 28 | SiO₂ | 163.07 | Air side | | |
| 56 | SiO₂ | 100.02 | 27 | TiO₂ | 87.17 | 40 | SiO₂ | 83.17 |
| 55 | TiO₂ | 22.12 | 26 | SiO₂ | 157.98 | 39 | TiO₂ | 94.18 |
| 54 | SiO₂ | 26.42 | 25 | TiO₂ | 91.17 | 38 | SiO₂ | 12.00 |
| 53 | TiO₂ | 12.02 | 24 | SiO₂ | 161.12 | 37 | TiO₂ | 23.80 |
| 52 | SiO₂ | 175.12 | 23 | TiO₂ | 99.63 | 36 | SiO₂ | 21.45 |
| 51 | TiO₂ | 112.59 | 22 | SiO₂ | 176.92 | 35 | TiO₂ | 93.20 |
| 50 | SiO₂ | 31.76 | 21 | TiO₂ | 105.13 | 34 | SiO₂ | 12.00 |
| 49 | TiO₂ | 23.62 | 20 | SiO₂ | 174.38 | 33 | TiO₂ | 12.00 |
| 48 | SiO₂ | 12.00 | 19 | TiO₂ | 100.28 | 32 | SiO₂ | 126.91 |
| 47 | TiO₂ | 95.41 | 18 | SiO₂ | 167.67 | 31 | TiO₂ | 12.00 |
| 46 | SiO₂ | 176.99 | 17 | TiO₂ | 95.95 | 30 | SiO₂ | 15.33 |
| 45 | TiO₂ | 145.89 | 16 | SiO₂ | 170.90 | 29 | TiO₂ | 73.38 |
| 44 | SiO₂ | 12.62 | 15 | TiO₂ | 44.43 | 28 | SiO₂ | 163.41 |
| 43 | TiO₂ | 35.29 | 14 | SiO₂ | 12.00 | 27 | TiO₂ | 82.26 |
| 42 | SiO₂ | 181.90 | 13 | TiO₂ | 33.74 | 26 | SiO₂ | 36.81 |
| 41 | TiO₂ | 93.00 | 12 | SiO₂ | 158.05 | 25 | TiO₂ | 12.00 |
| 40 | SiO₂ | 152.33 | 11 | TiO₂ | 12.00 | 24 | SiO₂ | 74.65 |
| 39 | TiO₂ | 88.65 | 10 | SiO₂ | 12.00 | 23 | TiO₂ | 98.66 |
| 38 | SiO₂ | 152.53 | 9 | TiO₂ | 65.31 | 22 | SiO₂ | 135.21 |
| 37 | TiO₂ | 87.50 | 8 | SiO₂ | 12.33 | 21 | TiO₂ | 12.00 |
| 36 | SiO₂ | 155.77 | 7 | TiO₂ | 12.00 | 20 | SiO₂ | 14.05 |
| 35 | TiO₂ | 94.00 | 6 | SiO₂ | 156.63 | 19 | TiO₂ | 69.85 |
| 34 | SiO₂ | 213.52 | 5 | TiO₂ | 25.35 | 18 | SiO₂ | 162.21 |
| 33 | TiO₂ | 12.00 | 4 | SiO₂ | 13.25 | 17 | TiO₂ | 83.82 |
| 32 | SiO₂ | 61.71 | 3 | TiO₂ | 53.30 | 16 | SiO₂ | 32.33 |
| 31 | TiO₂ | 19.78 | 2 | SiO₂ | 31.24 | 15 | TiO₂ | 12.00 |
| 30 | SiO₂ | 12.00 | 1 | TiO₂ | 14.04 | 14 | SiO₂ | 63.90 |

| | | | | | | |
|---|---|---|---|---|---|---|
| 29 | TiO₂ | 86.82 | Light-absorbing layer side | 13 | TiO₂ | 12.00 |

| | | |
|---|---|---|
| 12 | SiO₂ | 12.00 |
| 11 | TiO₂ | 90.12 |
| 10 | SiO₂ | 57.37 |
| 9 | TiO₂ | 12.00 |
| 8 | SiO₂ | 58.29 |
| 7 | TiO₂ | 115.99 |
| 6 | SiO₂ | 31.82 |
| 5 | TiO₂ | 31.91 |
| 4 | SiO₂ | 16.35 |
| 3 | TiO₂ | 82.18 |
| 2 | SiO₂ | 29.41 |
| 1 | TiO₂ | 16.69 |

Light-absorbing layer side

TABLE 3
Type of multilayer film: 2A

| | | |
|---|---|---|
| | Film | Physical film |
| No. | material | thickness [nm] |

Substrate side

| | | |
|---|---|---|
| 1 | TiO₂ | 19.42 |
| 2 | SiO₂ | 20.70 |
| 3 | TiO₂ | 134.69 |
| 4 | SiO₂ | 34.67 |
| 5 | TiO₂ | 16.59 |
| 6 | SiO₂ | 263.74 |
| 7 | TiO₂ | 16.08 |
| 8 | SiO₂ | 34.91 |
| 9 | TiO₂ | 88.57 |
| 10 | SiO₂ | 17.52 |
| 11 | TiO₂ | 21.56 |
| 12 | SiO₂ | 238.65 |
| 13 | TiO₂ | 17.37 |
| 14 | SiO₂ | 39.27 |
| 15 | TiO₂ | 108.37 |
| 16 | SiO₂ | 16.71 |
| 17 | TiO₂ | 15.44 |
| 18 | SiO₂ | 222.63 |
| 19 | TiO₂ | 18.94 |
| 20 | SiO₂ | 38.53 |
| 21 | TiO₂ | 111.97 |
| 22 | SiO₂ | 13.20 |
| 23 | TiO₂ | 13.51 |
| 24 | SiO₂ | 210.54 |
| 25 | TiO₂ | 22.18 |
| 26 | SiO₂ | 33.28 |
| 27 | TiO₂ | 110.05 |
| 28 | SiO₂ | 11.75 |
| 29 | TiO₂ | 18.43 |
| 30 | SiO₂ | 211.05 |
| 31 | TiO₂ | 23.84 |
| 32 | SiO₂ | 31.79 |
| 33 | TiO₂ | 128.40 |
| 34 | SiO₂ | 24.90 |
| 35 | TiO₂ | 9.00 |
| 36 | SiO₂ | 173.65 |
| 37 | TiO₂ | 22.06 |
| 38 | SiO₂ | 21.25 |
| 39 | TiO₂ | 128.14 |
| 40 | SiO₂ | 21.15 |
| 41 | TiO₂ | 22.18 |
| 42 | SiO₂ | 216.06 |
| 43 | TiO₂ | 27.91 |
| 44 | SiO₂ | 26.60 |
| 45 | TiO₂ | 62.35 |
| 46 | SiO₂ | 31.38 |
| 47 | TiO₂ | 24.51 |
| 48 | SiO₂ | 242.12 |
| 49 | TiO₂ | 21.12 |
| 50 | SiO₂ | 31.35 |
| 51 | TiO₂ | 100.44 |
| 52 | SiO₂ | 15.03 |
| 53 | TiO₂ | 22.54 |
| 54 | SiO₂ | 228.19 |
| 55 | TiO₂ | 19.49 |
| 56 | SiO₂ | 58.65 |
| 57 | TiO₂ | 30.47 |
| 58 | SiO₂ | 49.03 |
| 59 | TiO₂ | 26.72 |
| 60 | SiO₂ | 115.44 |

Air side

TABLE 4
Type of multilayer film: 3A

| | | |
|---|---|---|
| | Film | Physical film |
| No. | material | thickness [nm] |

Light-absorbing layer side

| | | |
|---|---|---|
| 11 | TiO₂ | 17.36 |
| 10 | SiO₂ | 35.02 |
| 9 | TiO₂ | 140.56 |
| 8 | SiO₂ | 19.91 |
| 7 | TiO₂ | 49.40 |
| 6 | SiO₂ | 12.00 |
| 5 | TiO₂ | 71.16 |
| 4 | SiO₂ | 12.00 |
| 3 | TiO₂ | 143.76 |
| 2 | SiO₂ | 31.17 |
| 1 | TiO₂ | 18.36 |

Substrate side

With respect to the respective optical filters obtained as described above, spectral transmittance curves at an incident angle of 0 degrees and spectral reflectance curves at an incident angle of 5 degrees and an incident angle of 30 degrees in a wavelength range of 350 nm to 1,200 nm were measured using an ultraviolet-visible spectrophotometer.

Respective characteristics shown in the following Table 6 were calculated based on the obtained data of the spectral characteristics.

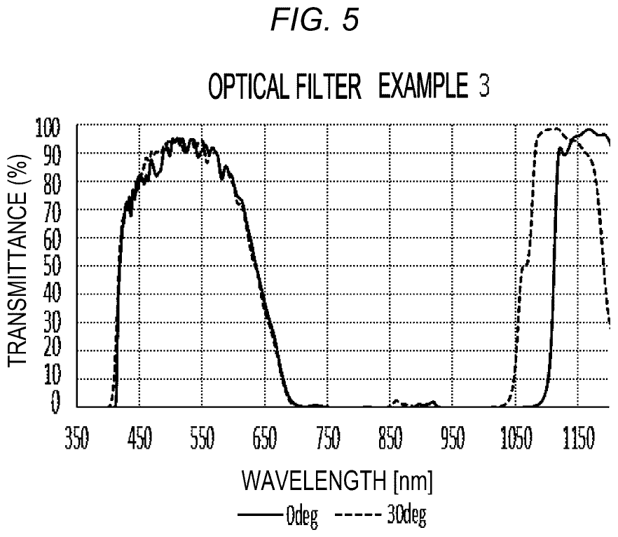

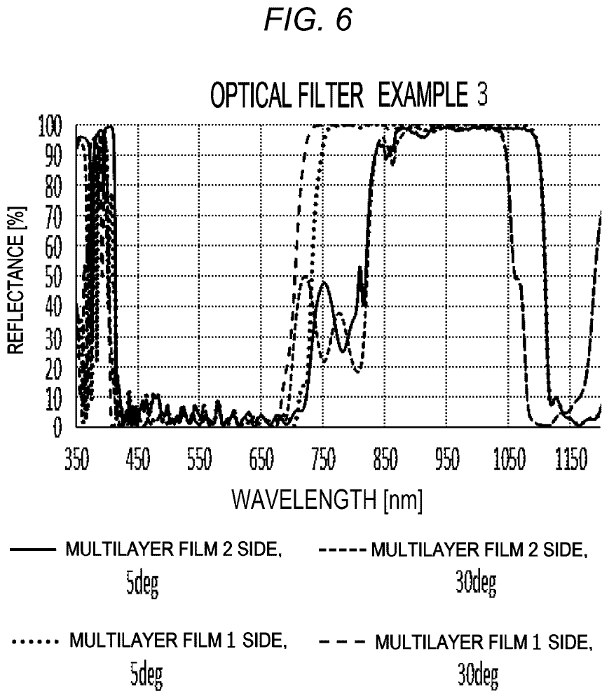

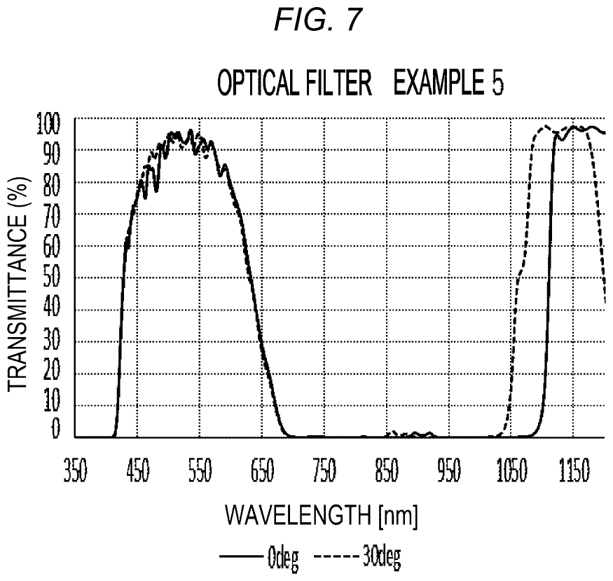

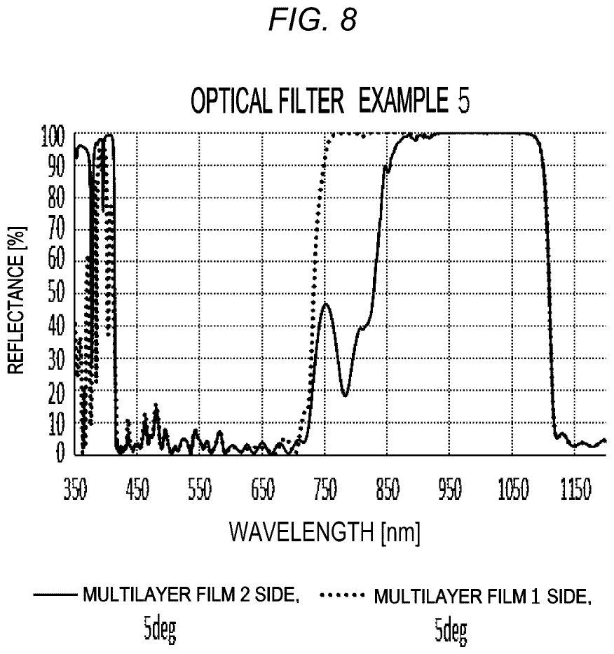

In addition, curves of spectral transmittance and reflectance of the respective optical filters of Examples 3 and 5 are shown in FIGS. 5 to 8, respectively.

Examples 1 to 4 are inventive examples, and Examples 5 to 9 are comparative examples.

TABLE 5

| | | Example | Example | Example | Example | Example | Example | Example | Example | Example |
|---|---|---|---|---|---|---|---|---|---|---|
| Optical filter | | 1 | 2 | 3 | 4 | 5 | 6 | 7 | 8 | 9 |
| Dielectric | Type of | 1A | 1B | 1A | 1B | 1C | 1D | 1E | 1C | 1B |
| multilayer | multilayer film | | | | | | | | | |
| film 1 | Film material | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ |
| | Number of | 56 | 40 | 56 | 40 | 8 | 16 | 40 | 8 | 56 |
| | laminated layers | | | | | | | | | |
| | Physical film | 4,800.42 | 2,198.71 | 4,800.42 | 2,198.71 | 346.43 | 1,999.36 | 2,838.5 | 346.43 | 4,800.42 |
| | thickness [nm] | | | | | | | | | |
| Light- | Type of light- | 1 | 1 | 1 | 1 | 2 | 1 | 1 | 1 | 3 |
| absorbing | absorbing layer | | | | | | | | | |
| layer | Type of resin | Polyimide | Polyimide | Polyimide | Polyimide | Polyimide | Polyimide | Polyimide | Polyimide | Polyester |
| | Tg of resin (° C.) | 320 | 320 | 320 | 320 | 320 | 320 | 320 | 320 | 150 |
| | Dye | 3 types | 3 types | 3 types | 3 types | 4 types | 3 types | 3 types | 3 types | 3 types |
| | Physical film | 1.4 | 1.4 | 1.4 | 1.4 | 1.1 | 1.4 | 1.4 | 1.4 | 1.4 |
| | thickness [nm] | | | | | | | | | |
| Dielectric | Type of | — | — | 3A | 3A | — | — | — | — | — |
| multilayer | multilayer film | | | | | | | | | |
| film 3 | Film material | | | TiO₂/SiO₂ | TiO₂/SiO₂ | | | | | |
| | Number of | | | 11 | 11 | | | | | |
| | laminated layers | | | | | | | | | |
| | Physical film | | | 550.7 | 550.7 | | | | | |
| | thickness [nm] | | | | | | | | | |
| Glass | Type | Glass B | Glass A | Glass B | Glass A | Glass B | Glass B | Glass B | Glass B | Glass B |
| substrate | Sheet thickness | 0.30 | 0.56 | 0.30 | 0.56 | 0.30 | 0.30 | 0.30 | 0.30 | 0.30 |
| | └mm┘ | | | | | | | | | |
| Dielectric | Type of | 2A | 2A | 2A | 2A | 2B | 2C | 2D | 2E | 2A |
| multilayer | multilayer film | | | | | | | | | |
| film 2 | Film material | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ |
| | Number of | 60 | 60 | 60 | 60 | 52 | 60 | 48 | 108 | 60 |
| | laminated layers | | | | | | | | | |
| | Physical film | 4,096.08 | 4,096.08 | 4,096.08 | 4,096.08 | 4,261.96 | 3,127.91 | 2,896.41 | 8,790.44 | 4,096.08 |
| | thickness [nm] | | | | | | | | | |

TABLE 6

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4 | ple 5 | ple 6 | ple 7 | ple 8 | ple 9 |
| Optical | S1(0)/S2(0) | 70.5 | 235.5 | 221.9 | 72.7 | 1.4 | 1.8 | 12.6 | 345.1 | 321.0 |
| filter | S3(0)/S2(0) | 98.0 | 191.9 | 174.2 | 98.2 | 0.0 | 0.1 | 7.6 | 249.2 | 273.7 |
| spectral | S1(30)/S2(30) | 48.1 | 349.6 | 311.4 | 48.2 | 1.9 | 1.6 | 3.6 | 956.8 | 352.8 |
| charac- | S3(30)/S2(30) | 53.7 | 276.5 | 238.9 | 52.2 | 0.1 | 0.1 | 1.5 | 641.3 | 291.4 |
| teristics | Absolute value of difference between | 380 | 474 | 476 | 382 | 168 | 265 | 352 | 380 | 380 |
| | wavelength at which transmittance of light | | | | | | | | | |
| | having wavelength of 550 nm to 750 nm is | | | | | | | | | |
| | 50% at incident angle of 0 degrees and | | | | | | | | | |
| | wavelength at which transmittance of light | | | | | | | | | |
| | having wavelength of 950 nm to 1,150 nm | | | | | | | | | |
| | is 50% at incident angle of 0 degrees [nm] | | | | | | | | | |
| | Difference between S1(0)/S2(0) and | 22.4 | 114.1 | 89.5 | 24.5 | 0.5 | 0.1 | 9.0 | 611.7 | 31.8 |
| | S1(30)/S2(30) | | | | | | | | | |
| | Difference between S3(0)/S2(0) and | 44.3 | 84.6 | 64.6 | 46.0 | 0.1 | 0.0 | 6.1 | 392.1 | 17.7 |
| | S3(30)/S2(30) | | | | | | | | | |
| | Wavelength IR50S when incident on | 738 | 732 | 732 | 738 | — | 703 | 772 | 821 | 732 |
| | multilayer film 1 side [nm] | | | | | | | | | |
| | Wavelength IR50L when incident on | 986 | 1,110 | 1,110 | 987 | — | 901 | 988 | 1,108 | 1,109 |
| | multilayer film 1 side └nm┘ | | | | | | | | | |
| | Difference between wavelengths IR50S | 248 | 378 | 378 | 249 | — | 198 | 216 | 287 | 377 |
| | and IR50L [nm] | | | | | | | | | |
| | Average reflectance G1 of light of 450 nm | 1.6 | 4.1 | 4.5 | 2 | 2.2 | 2.5 | 1.1 | 3.0 | 4.2 |
| | to 600 nm when incident on multilayer film | | | | | | | | | |
| | 1 side at incident angle of 5 degrees [%] | | | | | | | | | |
| | Average reflectance P1 of light of 450 nm | 1.5 | 4.3 | 4.6 | 2 | 2.2 | 2.7 | 1.1 | 2.9 | 4.4 |
| | to 600 nm when incident on multilayer film | | | | | | | | | |
| | 2 side at incident angle of 5 degrees [%] | | | | | | | | | |
| | \|G1 − P1\| [%] | 0.09 | 0.18 | 0.12 | 0.17 | 0.04 | 0.27 | 0.07 | 0.16 | 0.23 |

From the above results, in the optical filters of Examples 1 to 4, both S1₍₀₎/S2₍₀₎ and S1₍₃₀₎/S2₍₃₀₎ are equal to or greater than a certain value, and thus transmittance in a visible light region is maintained high even at a high incident angle, and transmittance in a region having a wavelength of 700 nm to 1,000 nm to be shielded is controlled low. Both S3₍₀₎/S2₍₀₎ and S3₍₃₀₎/S2₍₃₀₎ are equal to or greater than a certain value, and thus transmittance in a near-infrared light region having a wavelength of 1,000 nm to 1,300 nm is maintained high even at a high incident angle, and transmittance in a region having a wavelength of 700 nm to 1,000 nm to be shielded is controlled low.

In addition, from a comparison between Example 1 and Example 2 and a comparison between Example 3 and Example 4, it is understood that by using the light-absorbing glass as the glass substrate, the absolute value of the difference between S1₍₀₎/S2₍₀₎ and S1₍₃₀₎/S2₍₃₀₎ and the absolute value of the difference between S3₍₀₎/S2₍₀₎ and S3₍₃₀₎/S2₍₃₀₎ become smaller, and a change in the spectral characteristics due to the incident angle is prevented.

Further, from a comparison between Example 1 and Example 3 and a comparison between Example 2 and Example 4, it is understood that the absolute value of the difference between S1₍₀₎/S2₍₀₎ and S1₍₃₀₎/S2₍₃₀₎ and the absolute value of the difference between S3₍₀₎/S2₍₀₎ and S3₍₃₀₎/S2₍₃₀₎ can be reduced also by providing the dielectric multilayer film 3 between the substrate and the light-absorbing layer.

On the other hand, in the optical filters of Examples 5 to 7, S1₍₀₎/S2₍₀₎, S1₍₃₀₎/S2₍₃₀₎, S3₍₀₎/S2₍₀₎, and S3₍₃₀₎/S2₍₃₀₎ were below 40. This is because wavelengths for maintaining high transmittance in the near-infrared light region are different.

In the optical filter of Example 8, since the film thickness of the dielectric multilayer film 1 laminated on the light-absorbing layer side is small, it is necessary to increase the film thickness of the dielectric multilayer film 2 on the other side in order to ensure the light shielding properties, and the spectral characteristics are easily affected by the incident angle.

In the optical filter of Example 9, since the glass transition temperature of the resin in the light-absorbing layer is low, the optical filter is easily affected by a stress of the dielectric multilayer film 1 laminated on the light-absorbing layer.

### <Heat Resistance Test>

The optical filters obtained in Examples 3 and 9 were cut into a size of 5 mm square by blade dicing. The obtained test piece was heated on a hot plate at 200° C. for 10 minutes, and the appearance thereof was confirmed with a metallurgical microscope.

In the optical filter of Example 3 in which a polyimide resin having a glass transition temperature of 320° C. was used for the light-absorbing layer, there was no change in the appearance.

On the other hand, in Example 9 in which a polyester resin having a glass transition temperature of 150° C. was used for the light-absorbing layer, wrinkles were generated on the light-absorbing layer. The reason is considered to be that the resin becomes soft at a high temperature and a resin having a low glass transition temperature is more deformed due to a stress of the dielectric multilayer film.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-210430) filed on Dec. 13, 2023, the contents of which are incorporated herein by reference.

### INDUSTRIAL APPLICABILITY

The optical filter according to the present embodiment is excellent in transmittance of visible light and specific near-infrared light even at a high incident angle, and is excellent in shielding properties of other near-infrared light. The optical filter is useful for applications of imaging devices such as cameras and sensors for transport machines, for which high performance has been achieved in recent years.

What is claimed is:

1. An optical filter comprising:
a dielectric multilayer film 1;
a light-absorbing layer;
a glass substrate; and
a dielectric multilayer film 2 in this order, wherein
the dielectric multilayer film 1 has a thickness of 1,500 nm or more,
the light-absorbing layer comprises a resin having a glass transition temperature of 200° C. or higher and a near-infrared ray absorbing dye, and
the optical filter satisfies the following spectral characteristics (i-1) and (i-2):
(i-1) when a sum of a transmittance of a light having a wavelength of 450 nm to 700 nm at an incident angle of 0 degrees is defined as S1₍₀₎, a sum of a transmittance of a light having a wavelength of 700 nm to 1,000 nm at an incident angle of 0 degrees is defined as S2₍₀₎, and a sum of a transmittance of a light having a wavelength of 1,000 nm to 1,300 nm at an incident angle of 0 degrees is defined as S3₍₀₎,
S1₍₀₎/S2₍₀₎≥40 and S3₍₀₎/S2₍₀₎≥40 are satisfied, and
(i-2) when a sum of a transmittance of the light having a wavelength of 450 nm to 700 nm at an incident angle of 30 degrees is defined as S1₍₃₀₎, a sum of a transmittance of the light having a wavelength of 700 nm to 1,000 nm at an incident angle of 30 degrees is defined as S2₍₃₀₎, and a sum of a transmittance of the light having a wavelength of 1,000 nm to 1,300 nm at an incident angle of 30 degrees is defined as S3₍₃₀₎,
S1₍₃₀₎/S2₍₃₀₎≥40 and S3₍₃₀₎/S2₍₃₀₎≥40 are satisfied.

2. The optical filter according to claim 1, wherein the optical filter further satisfies the following spectral characteristic (i-3):
(i-3) an absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.

3. The optical filter according to claim 1, wherein the optical filter further satisfies the following spectral characteristics (i-4) and (i-5):
(i-4) an absolute value of a difference between S1₍₀₎/S2₍₀₎ and S1₍₃₀₎/S2₍₃₀₎ is 200 or less, and
(i-5) an absolute value of a difference between S3₍₀₎/S2₍₀₎ and S3₍₃₀₎/S2₍₃₀₎ is 200 or less.

4. The optical filter according to claim 1, wherein the optical filter further satisfies all of the following spectral characteristics (i-6) to (i-8):
(i-6) a wavelength IR_{50S} at which a reflectance of a light at an incident angle of 5 degrees is 50% is in a range of 650 nm to 830 nm when the light is incident from a dielectric multilayer film 1 side,
(i-7) a wavelength IR_{50L} at which the reflectance of the light at an incident angle of 5 degrees is 50% is in a range of 950 nm to 1,200 nm when the light is incident from the dielectric multilayer film 1 side, and
(i-8) an absolute value of a difference between the wavelength IR_{50S} and the wavelength IR_{50L} is 230 nm or more.

5. The optical filter according to claim 1, wherein the optical filter further satisfies the following spectral characteristics (i-9) and (i-10):
(i-9) an average reflectance of a light having a wavelength of 450 nm to 600 nm at an incident angle of 5 degrees is 5% or less when the light is incident from a dielectric multilayer film 1 side, and
(i-10) an average reflectance of the light having a wavelength of 450 nm to 600 nm at an incident angle of 5 degrees is 5% or less when the light is incident from a dielectric multilayer film 2 side.

6. The optical filter according to claim 1, wherein the optical filter further satisfies the following spectral characteristic (i-11):
(i-11) an absolute value of a difference between an average reflectance of a light having a wavelength of 450 nm to 600 nm at an incident angle of 5 degrees when the light is incident from a dielectric multilayer film 1 side and an average reflectance of the light having a wavelength of 450 nm to 600 nm at an incident angle of 5 degrees when the light is incident from a dielectric multilayer film 2 side is 0.5% or less.

7. The optical filter according to claim 3, wherein the optical filter further comprises a dielectric multilayer film 3 between the light-absorbing layer and the glass substrate,
the absolute value of the difference between S1₍₀₎/S2₍₀₎ and S1₍₃₀₎/S2₍₃₀₎ in the spectral characteristic (i-4) is 130 or less, and
the absolute value of the difference between S3₍₀₎/S2₍₀₎ and S3₍₃₀₎/S2₍₃₀₎ in the spectral characteristic (i-5) is 130 or less.

8. The optical filter according to claim 3, wherein the glass substrate is an ytterbium-containing glass substrate,
the absolute value of the difference between S1₍₀₎/S2₍₀₎ and S1₍₃₀₎/S2₍₃₀₎ in the spectral characteristic (i-4) is 130 or less; and
the absolute value of the difference between S3₍₀₎/S2₍₀₎ and S3₍₃₀₎/S2₍₃₀₎ in the spectral characteristic (i-5) is 130 or less.

9. The optical filter according to claim 1, wherein the resin in the light-absorbing layer comprises a polyimide resin.

10. The optical filter according to claim 1, wherein the near-infrared ray absorbing dye in the light-absorbing layer comprises:
a dye having a maximum absorption wavelength at a wavelength of 700 nm or more and less than 730 nm;
a dye having a maximum absorption wavelength at a wavelength of 730 nm or more and less than 760 nm; and
a dye having a maximum absorption wavelength at a wavelength of 760 nm or more and less than 800 nm.

11. The optical filter according to claim 1, wherein the light-absorbing layer has a thickness of 2 μm or less, and
a content of the near-infrared ray absorbing dye in the light-absorbing layer is 10 mass % or more.

12. An imaging device comprising the optical filter according to claim 1.
